(19) United States
(12) Patent Application Publication
(10) Pub. No.: US 2021/0182986 A1
(43) Pub. Date: Jun. 17, 2021

(54) METHOD AND APPARATUS FOR MONITORING HOMESHARING ACTIVITY

(71) Applicant: NGD HOMESHARING, LLC, Miami, FL (US)

(72) Inventors: Todd BUTLER, Miami, FL (US); Richard CHANDLER, Miami, FL (US); Harvey HERNANDEZ, Miami, FL (US)

(21) Appl. No.: 17/119,565

(22) Filed: Dec. 11, 2020

Related U.S. Application Data
(60) Provisional application No. 62/947,866, filed on Dec. 13, 2019.

(51) Int. Cl. G06Q 50/16; G06Q 30/02; G06Q 30/00; G06Q 10/02; G06Q 30/06; H04L 9/32; G06F 11/14; G06N 20/00

(52) U.S. Cl. CPC G06Q 50/16; G06Q 30/0201; G06Q 30/0204; G06Q 30/018; G06Q 10/02; G06N 20/00; G06Q 30/0218; G06Q 30/0645; H04L 9/3263; G06F 11/1448; G06Q 30/0282

(57) ABSTRACT

Certain example embodiments provide systems, methods, apparatuses, and computer program products for monitoring homesharing activity. For example, certain embodiments may determine how well each resident, in a residential apartment complex, is performing in relation to homesharing. Some embodiments may provide a technology platform (referred to herein as a “scoring platform”) that generates a homesharing score based on how much money a resident is making, how long it takes the resident to respond to guest messages, the ratings the resident receives on short term rental websites, the resident's hosting status, and how much money each resident has made in relationship to how much a company makes on units that the company manages and subleases. This score may then be used to target specific residents to assist them in the areas in which they are considered to be underachieving.

### CROSS-REFERENCE TO RELATED APPLICATION

This application claims the benefit of U.S. Provisional Patent Application No. 62/947,866, filed Dec. 13, 2019, the content of which is incorporated by reference herein in its entirety.

### FIELD

Some example embodiments may generally relate to homesharing, and more particularly, to monitoring homesharing activity.

### BACKGROUND

Homesharing includes situations where a property owner or manager leases extra living space or accommodations, such as an extra bedroom, to an individual on a short or long-term basis. Airbnb™ and Vrbo™ are example companies that provide homesharing platforms.

### SUMMARY

According to a first embodiment, a method may include collecting homesharing activity data. The homesharing activity data may be indicative of homesharing activities of one or more individuals and may be collected from at least one of: a homesharing platform, a pricing platform, or a rating or review platform. The method may include performing an analysis of the homesharing activity data. The method may include determining scores for the one or more individuals associated with the homesharing activity data. The scores may indicate levels of performance of the one or more individuals with respect to homesharing activities. The method may include identifying, based on the scores, a subset of the one or more individuals where the scores fail to satisfy one or more thresholds or where the scores satisfy the one or more thresholds. The method may include performing one or more actions based on the identification of the subset of the one or more individuals.

In a variant, the scoring platform may include one or more of: one or more certificate managers, one or more security certificates, one or more load balancers, one or more availability zone, one or more virtual clouds, one or more cloud servers, one or more backup snapshots, one or more cloud storages, one or more security groups, one or more database instance managers, one or more database instance standbys, one or more cloud management services, and one or more alarm or notification services. In a variant, the method may include validating that the homesharing activities occurred during a lease term. In a variant, the collecting may include collecting reservation-related data from the hosting platform, pricing information for homesharing activities provided by the one or more individuals, or rating information or review information for the homesharing activities provided by the one or more individuals.

In a variant, the method may further include establishing a communications link to one or more accounts hosted on the homesharing platform for the one or more individuals, and the collecting may include collecting the homesharing activity data from the homesharing platform via the communications link. In a variant, the performing may include evaluating the levels of performance of the homesharing activities of the one or more individuals in relation to one or more other individuals or one or more thresholds. In a variant, the determining may include assigning point values to the homesharing activities of the one or more individuals using a machine learning model, multiplying the point values by a percentage associated with the homesharing activities, and summing resulting point values after the multiplying.

In a variant, the performing may include generating one or more recommendations for the homesharing activities provided by the one or more individuals, and outputting the one or more recommendations to one or more accounts hosted on one or more servers. The one or more accounts may be associated with the one or more individuals. In a variant, the performing may include applying one or more rewards or one or more penalties to one or more accounts associated with the one or more individuals. The one or more rewards or the one or more penalties may be based on the scores. In a variant, the performing may include generating recommendations related to the homesharing activities for the one or more individuals, and outputting the recommendations to user equipment associated with the one or more individuals. In a variant, the performing may include generating reports associated with the one or more individuals based on the scores, the analysis, or the homesharing activity data. In a variant, the collecting may include collecting reservation-related data from the hosting platform, pricing information from the pricing platform, and rating information or review information from the rating or review platform.

A second embodiment may be directed to an apparatus including at least one processor and at least one memory comprising computer program code. The at least one memory and computer program code may be configured, with the at least one processor, to cause the apparatus at least to perform the method according to the first embodiment, or any of the variants discussed above.

A third embodiment may be directed to an apparatus that may include circuitry configured to cause the apparatus to perform the method according to the first embodiment, or any of the variants discussed above.

A fourth embodiment may be directed to an apparatus that may include means for performing the method according to the first embodiment, or any of the variants discussed above. Examples of the means may include one or more processors, memory, and/or computer program codes for causing the performance of the operation.

A fifth embodiment may be directed to a computer readable medium comprising program instructions stored thereon for causing an apparatus to perform at least the method according to the first embodiment, or any of the variants discussed above.

A sixth embodiment may be directed to a computer program product encoding instructions for causing an apparatus to perform at least the method according to the first embodiment, or any of the variants discussed above.

### BRIEF DESCRIPTION OF THE DRAWINGS

For proper understanding of example embodiments, reference should be made to the accompanying drawings, wherein:

FIG. 1 illustrates an example of monitoring homesharing activity, according to some embodiments;

FIG. 2a illustrates example output of a scoring platform, according to some embodiments;

FIG. 2b illustrates other example output of the scoring platform, according to some embodiments;

FIG. 3 illustrates an example of operations and certain data modules of the scoring platform, according to some embodiments;

FIG. 4 illustrates an example of elements associated with the scoring platform, according to some embodiments;

FIG. 5 illustrates an example flow diagram of a method, according to some embodiments; and

FIG. 6 illustrates an example block diagram of an apparatus, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for monitoring homesharing activity is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments. In addition, the phrase “set of” refers to a set that includes one or more of the referenced set members. As such, the phrases “set of,” “one or more of,” and “at least one of,” or equivalent phrases, may be used interchangeably. Further, “or” is intended to mean “and/or,” unless explicitly stated otherwise.

Additionally, if desired, the different functions or operations discussed below may be performed in a different order and/or concurrently with each other. Furthermore, if desired, one or more of the described functions or operations may be optional or may be combined. As such, the following description should be considered as merely illustrative of the principles and teachings of certain example embodiments, and not in limitation thereof.

Current building managers may have no way to monitor the homesharing activity that occurs in their buildings unless they sign up for, for example, the Airbnb™ Friendly Buildings program. When buildings participate in the Airbnb™ Friendly Buildings program, they may be given some homesharing data on the activity in their respective buildings, however, this information may be an aggregate view that makes it difficult to analyze. With the data provided by Airbnb™, it may also be difficult to get an all-encompassing view of the homesharing activity occurring in the building. A more robust system of measuring homesharing activity, including future activity, may be needed in order for a company to maximize revenues by targeting underperforming residents. Not only may a system be needed in order to collect data but to also analyze it to determine which residents need additional help in order to maximize their revenues and bring the highest possible commission to the company.

Some embodiments described herein may provide systems and/or methods for monitoring homesharing activity. For example, certain embodiments may determine how well each resident, in a residential apartment complex, is performing in relation to homesharing. Some embodiments may provide a technology platform (referred to herein as a “scoring platform”) that generates a homesharing score based on how much money a resident is making, how long it takes the resident to respond to guest messages, the ratings the resident receives on short term rental websites, the resident's hosting status, and how much money each resident has made in relationship to how much a company makes on units that the company manages and subleases on, for example, Airbnb™. This score may then be used to target specific residents to assist them in the areas in which they are considered to be underachieving. The collected data may also be used to help ensure the residents are following all of the terms and conditions of a homesharing program and/or to generally improve overall business processes and procedures. In addition, certain embodiments described herein may perform this improvement in a way that is not otherwise possible, such as due to the volume and/or complexity of data involved.

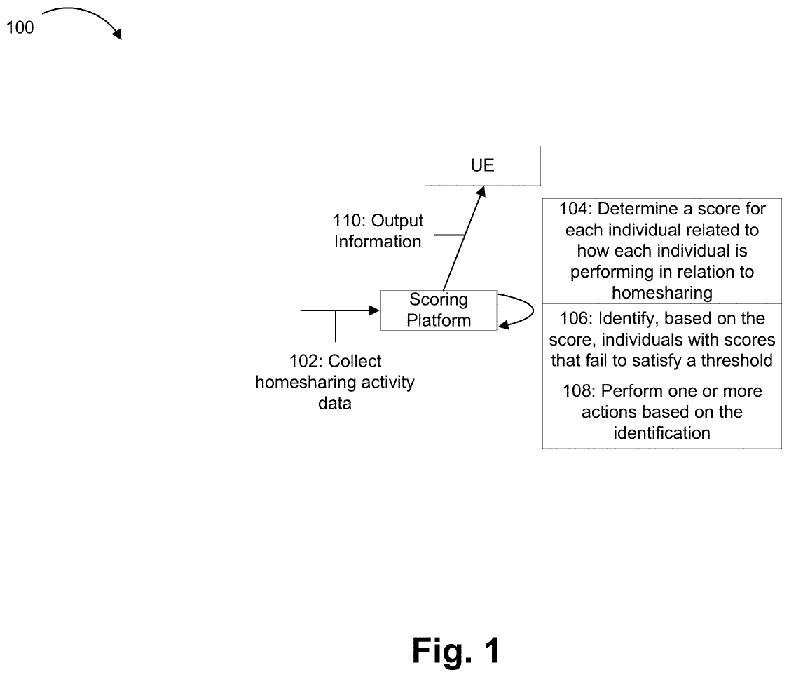

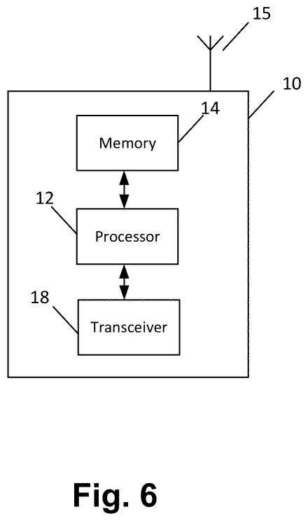

FIG. 1 illustrates an example 100 of monitoring homesharing activity, according to some embodiments. Specifically, FIG. 1 illustrates an example of how certain embodiments can solve the above described problems that currently face building operators that allow homesharing activity through collecting homesharing activity data on individuals (e.g., residents), including future activity, and determining how well each individual is performing in relation to homesharing. Based on an analysis of this data, a star rating, for example, may be determined for each individual, where the star rating may be representative of how well the individuals are performing As illustrated in FIG. 1, the example 100 includes a scoring platform and a user equipment. The scoring platform may include one or more computing devices (e.g., apparatuses 10 of FIG. 6). The user equipment may include one or more other computing devices.

As illustrated at 102, the scoring platform may collect homesharing activity data. For example, the scoring platform may collect the homesharing activity data from a server device, an application, an account, and/or the like associated with a homesharing platform, such as Airbnb™, a property manager, and/or the like. In certain embodiments, the homesharing activity data may include millions, billions, or more data elements for hundreds, thousands, or more individuals (e.g., individuals that rent living space and are able to engage in homesharing with respect to that living space). As described above, the scoring platform may collect the homesharing activity data from multiple sources. To do this, the scoring platform may correlate data from different sources to an individual, a property provided by the individual for homesharing, and/or the like. For example, the scoring platform may identify the same or a similar identifier (e.g., an individual's name, a property's address, or the like) across data sets from different sources to correlate data from the different sources.

In collecting the homesharing activity data, the scoring platform may collect reservation-related data from a homesharing platform. For example, the first set of data that may be collected is the individual's reservation transaction history from, for example, Airbnb™, or another homesharing platform. In order to collect the individual's personal data from their homesharing accounts, each individual may have to link their accounts to the scoring platform. For example, the individual may provide the scoring platform with an account identifier and/or security credentials for accessing the account, may grant the scoring platform permission to access the account, and/or the like. The scoring platform, once linked, may collect user-specific data from the homesharing platform's servers, via a connected network, that contain information about the homesharing activity in their respective accounts. This data, once collected, may be used to create a database (DB) table inside the scoring platform.

This data may include past and future reservation data, including a traveling party's name (e.g., a traveling party that reserves homesharing services with the individual), when a reservation was booked, when the reserving party arrives and departs, a number of nights for the reservation, a number of guests staying at the homesharing location, the reservation status, the confirmation number provided by the homesharing platform, cleaning fees for the listing, a nightly rate paid by the traveling party, and/or the total payment due to the individual for the homesharing services. Analysis of the collected data may include a determination of how much revenue the individual has made from homesharing, what percentage of time the individual participates in homesharing, and/or an average daily rate the individual was able to achieve. From this, it may also be determined how much commission is due to various parties as a result of the activity. This may be relevant data in determining how well an individual is performing in terms of homesharing.

The scoring platform may collect additional data from one or more other platforms, such as pricing information (e.g., homesharing fees, cleaning fees, etc.) from a pricing platform, rating and/or review information (e.g., star ratings of the individual, reviews of the accommodations provided by the individual, etc.) from a rating and/or review platform, and/or the like. A second table may also be created by the scoring platform, using the same dataset from the homesharing platform or from other platforms, with a summary of each individual who is operating as a homesharing host. This data may include an individual's name, an individual's hosting status with a homesharing platform, the average response time it takes the individual to respond to guest inquiries, the total revenue made by the individual, and/or the review score of their homesharing listing.

The scoring platform may perform an analysis of the homesharing activity data. For example, the scoring platform may evaluate the performance of the homesharing activities of an individual with respect to one or more other individuals or one or more thresholds to determine whether the individual's homesharing activities satisfy terms of an agreement, are at an acceptable level, and/or the like. Continuing with the previous example, the scoring platform may be configured with one or more thresholds that represent levels of homesharing activity agreed to in a contract, and may determine whether the homesharing activity data indicates that such levels of homesharing activity have been met by an individual. Additionally, or alternatively, the scoring platform may determine whether the homesharing activity (as determined through metrics) satisfies thresholds associated with acceptable levels of homesharing activity.

Analysis of the collected data may include a determination of how long it takes the individual to respond to guest inquiries, whether or not the individual has achieved, for example, a certain status on the homesharing platform, and/or the review score of their listing generated by guest reviews on the homesharing platform. This may be relevant data in determining how well a resident is performing in terms of homesharing.

To improve analysis of the resident's homesharing performance, other data points may be used. In order to associate the above-mentioned transaction data with specific residents, the scoring platform may have to match the transaction dates to the dates of any active long-term leases. This may have to be performed because residents sometimes move out or change apartments, and the transaction data may have to occur during a valid lease term for the scoring platform to consider the transaction valid.

The scoring platform may utilize a machine learning model to perform the analysis. For example, the machine learning model may process homesharing activity data that comprises millions, billions, or more data elements to identify trends or patterns in the data that indicate a performance of the individual with respect to home sharing activity (e.g., that indicate whether the individual is active in engaging in homesharing activity, whether the individual is maximizing homesharing activity and/or revenue, etc.). The machine learning model may be trained on historical homesharing activity data related to homesharing activity and tags that indicate a homesharing performance indicated by the historical homesharing activity data.

The dataset used, as described above, to validate that the transactions occur during a valid lease term may be provided by the property's operational technology platform. This technology platform, via a connected network, may provide data to the scoring platform. This data, once collected, may be used to create a database table in the scoring platform. This data may include an individual's name, the individual's unit number (e.g., apartment number), an individual's move-in date, an individual's move-out date, an individual's lease status (e.g., renewed, not renewed, expired, active, etc.), an individual's rent amount due, and/or an individual's concessions in the lease.

Since a company may own a data set that comprises information about its own performance on the homesharing platform with apartments the company leases back to itself, the company may also use this data to compare the individual's activity with that of the company's. Since the company may consider itself a professional host, this data may be relevant to determining if individuals associated with the company are able to achieve higher revenues, the same revenues, or lower revenues than the company. This dataset may be a transaction log of activity on the company's own accounts of the homesharing platform. The scoring platform, via a connected network, may obtain this information and, once obtained, may create a database table that includes various data points. This data may include past and future reservation data, including the traveling party's name, when the reservation was booked, when the reserving party arrives and departs, the number of nights, the number of guests staying, the reservation status, the confirmation number on the homesharing platform, the cleaning fees for the listing, the nightly rate paid by the traveling party, and/or the total payment due to the resident. Analysis of the collected data may include a determination of how the company's own revenue compares to that of the individual's, and how the company's own average nightly rates compare to that of the individual's.

As illustrated at 104, the scoring platform may determine a score for each individual associated with the homesharing activity data, where the score is related to, or indicates, how each individual is performing in relation to homesharing activity (e.g., a level of performance of the individual). For example, the scoring platform may determine a score on a scale after collecting the homesharing activity data. Based on the analysis of one or more database tables from the scoring platform, the scoring platform may be able to empirically assign each individual a score that may indicate how well each resident is performing in terms of subleasing their apartments on a homesharing platform (e.g., on a scale from 1 to 5, utilizing a number of stars or other icons, etc.). The scoring platform may analyze various data points and may generate an output score, as described below. This score may then be converted to, for example, a star rating, with five stars being the highest a resident can achieve. A five-star score may be representative of a host that is outperforming in the various homesharing activities analyzed.

In certain embodiments, the scoring platform may assign a point value to homesharing activity of an individual. For example, the scoring platform may assign the point value based on the homesharing activity satisfying a threshold, based on a machine learning model evaluating metrics for combinations of homesharing activities, and/or the like. The scoring platform may apply corresponding weightings (e.g., percentages) to the point values for different homesharing activities. The scoring platform may then determine the score based on the weighted point values (e.g., by summing the point values, determining an average of the point values, etc.).

In certain embodiments, the scoring platform may utilize a machine learning model to determine the score. For example, the machine learning model may process a result of the analysis to identify trends or patterns in the data that indicate a score for the analysis. The machine learning model may be trained on historical data related to analyses of homesharing activity and tags that indicate a score for the analyses. In certain embodiments, the machine learning model may be capable of processing analyses for hundreds, thousands, or more individuals simultaneously or in a short time period (e.g., a few seconds or minutes).

Operations described herein may occur automatically in the scoring platform and the score may be updated automatically each time any of the datasets are updated or changed via the connected network. The scoring platform may also automatically trigger an alert any time a resident's score, for example, increases at least one level (e.g., star level) or decreases at least one level. The scoring platform may then use this information to contact specific individuals to help them improve their score or to notify them of their successes, which may lead to broader support of the homesharing program.

The platform provided by some embodiments may also analyze the various scores by category, the categories including total revenue made, the individuals' total program adoption, their hosting status, their listing reviews, and/or their average daily rates. When analyzing how each resident performs in each specific category, the scoring platform may be able to determine the biggest factors that are impacting the score automatically. The scoring platform may then provide a specific action plan or recommendations for each individual that outlines the areas they need to work on in order to improve their overall score and actions that can be taken to try to achieve that improvement, as described in more detail elsewhere herein.

As illustrated at 106, the scoring platform may identify, based on the score, individuals with scores that fail to satisfy a threshold. For example, the scoring platform may identify individuals with scores that satisfy a threshold (e.g., meet or exceed a threshold) or that fail to satisfy the threshold (e.g., that fail to meet or exceed the threshold). Based on the score generated by the scoring platform, the scoring platform may identify individuals with scores of less than, for example, five stars with the purpose of helping the individuals improve their scores by booking additional nights and revenues through a homesharing platform. As a result, the commission payments to the company associated with the platform may be increased through increased or optimized homesharing activity.

As illustrated at 108, the scoring platform may perform one or more actions based on the identification. For example, the scoring platform may perform one or more actions with respect to individuals that are associated with a score that satisfies a threshold and/or individuals that are associated with a score that fails to satisfy a threshold.

In some embodiments, the scoring platform may generate a recommendation based on the score, the analysis on which the score is based, and/or the homesharing activity data on which the analysis was performed. For example, the scoring platform may identify which aspects of the analysis and/or the homesharing activity data caused the resulting score and may generate a recommendation for the individual to improve the score. As a specific example, the scoring platform may identify that the individual does not engage in homesharing activity on the weekends, may determine that this has caused the individual to receive a low score, and may generate a recommendation for the individual to increase their homesharing activity on the weekends. In some embodiments, the scoring platform may generate benchmarks and/or goals related to the recommendation (e.g., a goal for the individual in the previous example to increase their homesharing activity by one additional weekend per month).

Additionally, or alternatively, the scoring platform may generate a reward or a penalty associated with a score and/or a recommendation. For example, the scoring platform may determine a reward for an individual associated with a threshold score and may apply that score to an account associated with the individual, may determine a reward (e.g., a commission, a reduction in rent, and/or the like) for an individual if they complete goals or meet benchmarks for a recommendation, may determine a penalty for failing to complete goals or meet benchmarks for a recommendation (e.g., a loss of access to certain amenities, a loss of rewards points, and/or the like), and/or the like.

Additionally, or alternatively, the scoring platform may implement one or more recommendations. For example, the scoring platform may modify an advertised price for homesharing services, may generate an advertisement for homesharing services and may post the advertisement to a website (e.g., by providing the advertisement to a server that hosts the website), and/or the like. In some embodiments, the scoring platform may provide information for these actions to an individual associated with the property to be used for homesharing for approval of the actions (e.g., where the individual may make selections on a user interface to approve or disapprove the actions).

Additionally, or alternatively, the scoring platform may schedule a meeting between an individual and, e.g., a property manager, and may generate and send a meeting invite to an account or a device associated with the individual. For example, the meeting may be related to the individual's score. Additionally, or alternatively, the scoring platform may generate a report (e.g., related to the determined score and/or the performed analysis). For example, the scoring platform may utilize a digital template that comprises blank data fields, and may populate the template with homesharing activity data, personal information of the individual, a score for the individual, a result of the analysis, and/or the like. In certain embodiments, the scoring platform may use a machine learning model to determine which information to include in the report based on the information's contribution to the score, to the result of the analysis, and/or the like. The scoring platform may store the report, may populate a user interface with an icon and/or a uniform resource identifier (URI) for the report, may output the report to a device (e.g., associated with a property manager), and/or the like.

Through the various database tables created during this process, the scoring platform may also be able to create a view (e.g., a virtual map or representation) of the homesharing activity in a building (e.g., a residential apartment complex). Through this data, the scoring platform may facilitate management of staffing and may facilitate altering of activity that may violate terms and conditions of a homesharing program. For example, the homesharing platform may identify patterns of activity that are not permitted by a lease.

As illustrated at 110, the scoring platform may output information (e.g., a generated recommendation, a reward, and/or a penalty). For example, the scoring platform may output the information to a UE (e.g., as a push notification to an application or the UE, as a text message, or an email), may populate an account with the information, may update a database with the information, and/or the like.

As described above, FIG. 1 is provided as an example. Other examples are possible, according to some embodiments.

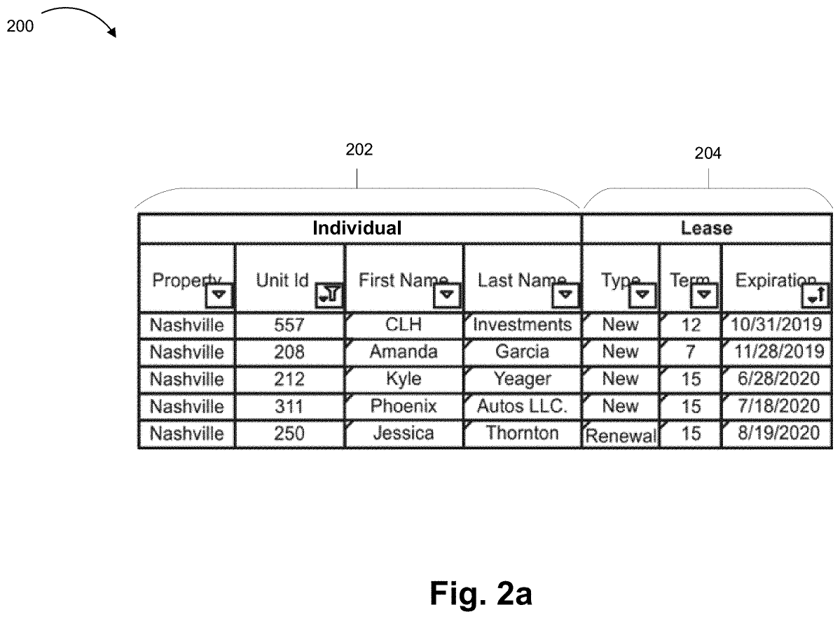

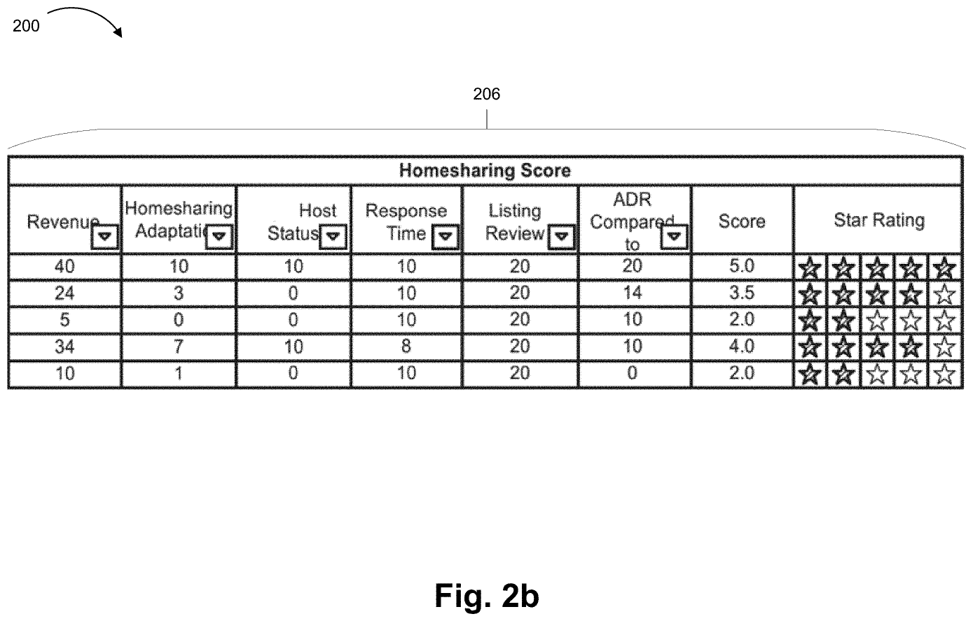

FIGS. 2a and 2b illustrate example output 200 of the scoring platform, according to some embodiments. As illustrated at 202, the output 200 may include a data structure that includes data elements related to an individual engaged in homesharing activity. For example, the output 200 may include property location (“Property” in FIG. 2a), unit identifier that identifies a particular property associated with the homesharing activity (“Unit Id” in FIG. 2a), first name of the individual, and last name of the individual as data elements. As illustrated at 204, the output 200 may include a data structure that includes data elements related to an individual's lease. For example, the output 200 may include a lease type (“Type” in FIG. 2a), a term of the lease (“Term” in FIG. 2a), and an expiration date of the lease (“Expiration” in FIG. 2a) as data elements.

Turning to FIG. 2b, which illustrates further aspects of the output 200, the output 200 may include one or more additional data structures comprising data elements. As illustrated at 206, the output 200 may include a data structure that includes data elements related to a homesharing score. For example, the output 200 may include revenue, homesharing adaptation, host status, response time, listing review, score, and/or star rating data elements related to an individual's homesharing score.

As indicated above, FIGS. 2a and 2b are provided as examples. Other examples are possible, according to some embodiments. For instance, the data elements illustrated at 202 and/or 204 may be included in the same data structure, as illustrated in FIG. 2a, or may be included in different data structures. Additionally, or alternatively, the data elements illustrated at 202 and/or 204 may be combined in one or more ways with the data elements illustrated at 206 into one or more data structures. Furthermore, the output 200 may include additional or different data elements than those illustrated in FIGS. 2a and 2b.

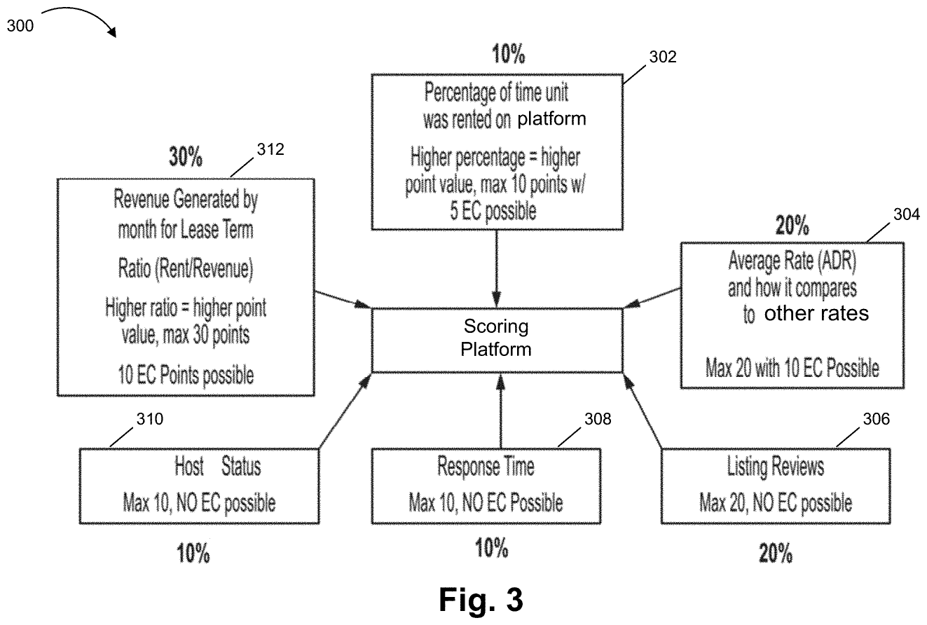

FIG. 3 illustrates an example 300 of operations and certain data modules of the scoring platform, according to some embodiments. As illustrated, the example 300 may include the scoring platform. The example 300 may illustrate weightings of different information that the scoring platform may apply to determine the score for an individual's homesharing activity. As illustrated at 302, the scoring platform may apply a first weighting (e.g., 10 percent (%)) to information of a first data module that comprises the percentage of time the individual's property (e.g., unit) was rented on a homesharing platform. For example, a higher percentage may result in a higher point value, and thus a higher score. With respect to the data module at 302, there may be a maximum of, e.g., 10 points applied to a score for this information with up to 5 points of extra credit points possible. Extra credit may be applied based satisfaction of a condition, such as a percentage exceeding a threshold. In certain embodiments, extra credit may be applied up to the maximum number of points, or may cause the number of points to exceed the maximum.

As illustrated at 304, the scoring platform may apply a second weighting (e.g., 20%) to information of a second data module that comprises an average rate (e.g., per night rental rate) and how that rate compares to other rates (e.g., rates for other similarly sized or designed units on the same property). With respect to the data module at 304, as one example, there may be a maximum of, e.g., 10 points possible with up to 10 points of extra credit possible. The extra credit for this weighting may be applied based on the rate exceeding the other rates by a threshold amount.

As illustrated at 306, the scoring platform may apply a third weighting (e.g., 20%) to information of a third data module that comprises listing reviews (e.g., whether the individual's average review by those who receive homesharing services from the individual, whether any of the reviews are below a threshold, and/or the like). With respect to the data module at 306, as one example, there may be a maximum of, e.g., 20 points applied to a score for this information and no extra credit may be applied.

As illustrated at 308, the scoring platform may apply a fourth weighting (e.g., 10%) to information of a fourth data module that comprises response time for an individual engaging in homesharing activity (e.g., whether the individual's average response time to inquiries from those who receive homesharing services from the individual). With respect to the data module at 308, as an example, there may be a maximum of, e.g., 10 points applied to a score for this information and no extra credit may be applied.

As illustrated at 310, the scoring platform may apply a fifth weighting (e.g., 10%) to information of a fifth data module that comprises host status (e.g., individuals that engage in certain types or amounts of homesharing activity may be associated with a certain status, such as a silver, gold, or platinum status). With respect to the data module at 310, as an example, there may be a maximum of, e.g., 10 points applied to a score for this information and no extra credit may be applied.

As illustrated at 312, the scoring platform may apply a sixth weighting (e.g., 30%) to information of a sixth data module that comprises revenue generated by, e.g., month for the lease term of a lease of an individual engaging in homesharing activity (e.g., whether the amount of revenue generated by the individual exceeds a threshold or exceeds the threshold by a threshold amount), a ratio of rent that the individual pays to revenue generate by homesharing (e.g., where a higher ratio results in a higher point value being applied for this information), and/or the like. With respect to the data module at 312, as an example, there may be a maximum of, e.g., 30 points applied to a score for this information and up to 10 points of extra credit possible.

In certain embodiments, the scoring platform may calculate a score by multiplying the above-described percentages for certain information by the corresponding number of points, and may add the resulting values. This score may then be translated to a star rating, or some other indicator, based on whether the score satisfies one or more thresholds. For example, if the total number of possible points for an individual is 100, the scoring platform may assign a one star rating to an individual with fewer than 10 total points, a two star rating to an individual with at least 10 points and fewer than 20 points, and so forth.

In certain embodiments, the scoring platform may obtain the above-described information for determining a score from a server, an account hosted on the server, a database (e.g., generated by the scoring platform, as described elsewhere herein), an application, and/or the like,

As described above, FIG. 3 is provided as an example. Other examples are possible, according to some embodiments. For example, the number of weightings and the percentage values of the weightings may be modified as appropriate.

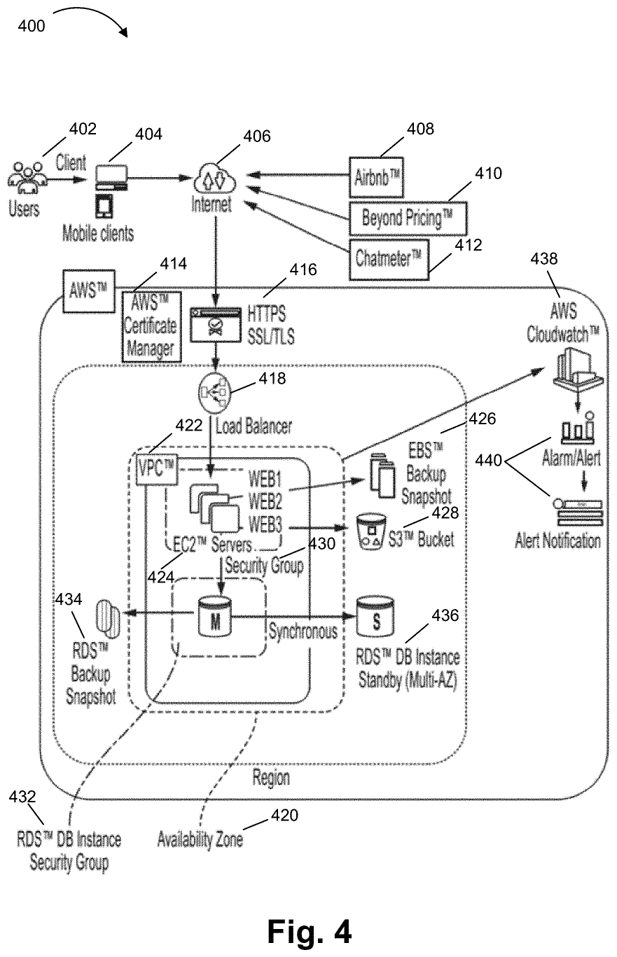

FIG. 4 illustrates an example 400 of elements associated with a scoring platform, with descriptions of various elements of the scoring platform, according to some embodiments. As illustrated, the elements of the example 400 may include users 402, mobile clients 404, the Internet 406, a homesharing platform 408, a pricing platform 410, a rating and/or review platform 412, a certificate manager 414, security certificates 416, a load balancer 418, an availability zone 420, a virtual cloud 422, cloud servers 424, a first backup snapshot 426, cloud storage 428, a security group 430, a database (DB) instance manager 432, a second backup snapshot 434, a DB instance standby 436, a cloud management service 438, and an alarm and/or notification service 440.

Users 402 may include one or more registered users of the scoring platform. Users 402 may access a website (from browsers) or an application associated with the scoring platform provided for display via the mobile clients 404 or other computing devices capable of providing user interface elements for display. Mobile clients 404 may include one or more computing devices that the registered users 402 of the scoring platform may use to access the scoring platform (e.g., from a mobile application installed on the mobile clients 404). Certain embodiments may include stationary clients (e.g., desktop computers), rather than mobile clients. Internet 406 may include the worldwide system of computer networks that fulfil the request(s) of the users 402. Some embodiments may include one or more additional or different networks, such as a cellular network, an intranet, a virtual private network (VPN), and/or the like.

The homesharing platform 408 may provide the homesharing activity data described elsewhere herein (e.g., via an application programming interface (API)) and the scoring platform may store this data. One example homesharing platform 408 is Airbnb™. The pricing platform 410 may provide pricing information for homesharing services (e.g., per night rental prices, cleaning fees, prices offered by other homesharing platforms and/or other individuals, etc.) to the scoring platform, and the scoring platform may store this information. Beyond Pricing™ is one example pricing platform 410. In certain embodiments, the scoring platform may call, for example, an API associated with the pricing platform 410 to get unit pricing information and may store that information. The scoring platform may also send that information to the homesharing platform 408.

The rating and/or review platform 412 may provide information related to ratings and/or reviews of individuals who provide homesharing services (e.g., the ratings and/or reviews may be provided by other individuals who receive the homesharing services), and the scoring platform may store this information. Chatmeter™ may be one example of a rating and/or review platform 412. In certain embodiments, the scoring platform may call, for example, an API to get social media reviews, or the like, and may store that information. The certificate manager 414 may include a service that provides provisioning, management, and/or deployment of public and private security certificates 416 for use with cloud services (e.g., Amazon™ web services (AWS™)) and/or internal connected resources. AWS™ Certificate Manager 414 may be one example of a certificate manager 414 and secure sockets layer and/or transport layer security (SSL/TLS) certificates may be an example of security certificates 416.

The load balancer 418 may distribute incoming application traffic across multiple cloud (e.g., Amazon™ elastic compute cloud (Amazon EC2™)) instances in multiple availability zones (AZs) 420. This may increase the fault tolerance of an application. Elastic load balancing may detect unhealthy instances of a device and/or application and may route traffic to healthy instances of the device and/or application.

The virtual cloud 422 may enable launching of resources into a virtual network that is defined. The virtual cloud 422 may be the networking layer for a cloud instance (e.g., Amazon EC2™). Amazon™ virtual private cloud (Amazon VPC™) may be an example of a virtual cloud 422. The cloud servers 424 may provide scalable computing capacity in a computing cloud (e.g., an Amazon™ web services (AWS™) cloud). Using a cloud servers 424 may eliminate a need to provide hardware up front, which may facilitate development and/or deployment of applications faster. The cloud servers 424 may be used to launch as many or as few virtual servers as needed, to configure security and/or networking, and/or to manage storage. The cloud servers 424 may enable scaling up or down to handle changes in resource utilization and/or spikes in popularity, reducing a need to forecast traffic. Amazon EC2™ servers are one example of cloud servers 424.

The first backup snapshot 426 may provide block level storage volumes for use with cloud (e.g., EC2™) instances. Volumes of data for the first backup snapshot 426 may behave like raw, unformatted block devices. These volumes may be mounted as devices on an application instance. Amazon™ elastic block store (Amazon EBS™) may be one example of the first backup snapshot 426. The cloud storage 428 may include a public cloud storage resource available in a cloud environment and/or an object storage offering. The cloud storage 428, which may be similar to file folders, may store objects that may comprise data and its descriptive metadata. AWS™ simple storage service (S3™) may be one example of the cloud storage 428.

The security group 430 may act as a virtual firewall for an application instance to control inbound and/or outbound traffic. The DB instance manager 432 may provide a selection of instance types optimized to fit different relational database use cases. Instance types may comprise varying combinations of central processing unit(s) (CPU(s)), memory, storage, and/or networking capacity, and may provide flexibility to choose an appropriate mix of resources for a database. Each instance type may include several instance sizes, allowing scaling of a database to the needs of a target workload. Amazon RDS™ is one example of the DB instance manager 432.

The second backup snapshot 434 may create a storage volume snapshot of a DB instance, backing up the entire DB instance and not just individual database tables. Creating this DB snapshot on a Single-AZ DB instance may result in a brief input/output (I/O) suspension that can last from a few seconds to a few minutes, depending on the size and/or class of the DB instance. Multi-AZ DB instances may not be affected by this I/O suspension since the backup is taken on the standby. Amazon RDS™ is one example of the second backup snapshot 434.

The DB instance standby 436 may provide enhanced availability and/or durability for DB Instances, possibly making them a fit for production database workloads. For example, the DB instance standby 436 may use multi-AZ deployments to provide this service. RDS™/DB Instance Standby (Multi-AZ) is one example of a DB instance standby 436. The cloud management service 438 may include a monitoring and/or management service that provides data and actionable insights for cloud (e.g., AWS™) hybrid, and on-premises applications and infrastructure resources. With the cloud management service 438, performance and/or operational data, in the form of logs and/or metrics, may be collected and/or accessed from a single platform. CloudWatch™ may be one example of the cloud management service 438. The alarm and/or notification service 440 may monitor metrics from the cloud management service 438 and/or may generate notifications when the metrics fall outside of the levels (high or low thresholds) that are configured.

As described above, FIG. 4 is provided as an example. Other examples are possible, according to some embodiments.

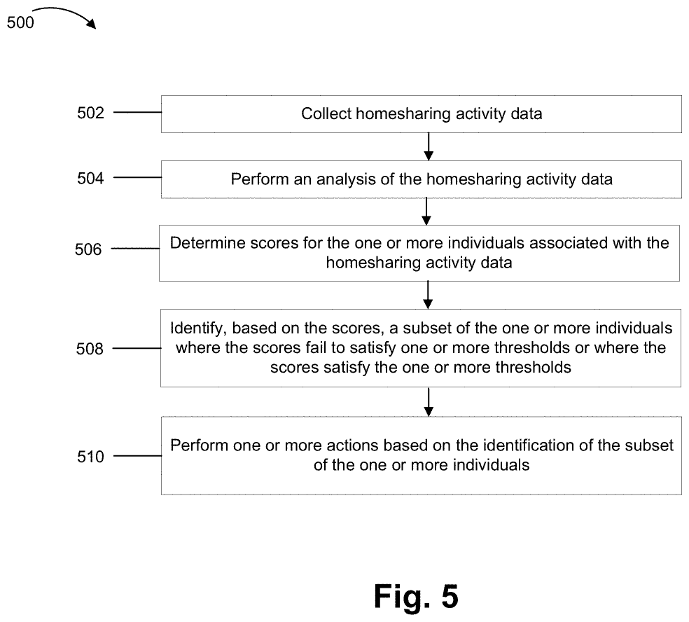

FIG. 5 illustrates an example flow diagram of a method 500, according to some embodiments. For example, FIG. 5 may illustrate example operations of a scoring platform that comprises one or more computing devices (e.g., one or more apparatuses 10 illustrated in, and described with respect to, FIG. 6). Some of the operations illustrated in FIG. 5 may be similar to some operations shown in, and described with respect to, FIGS. 1-4.

In an embodiment, the method may include, at 502, collecting homesharing activity data, for example, in a manner similar to that described at 102 of FIG. 1. The homesharing activity data may be indicative of homesharing activities of one or more individuals and may be collected from at least one of: a homesharing platform, a pricing platform, or a rating or review platform. The method may include, at 504, performing an analysis of the homesharing activity data. The method may include, at 506, determining scores for the one or more individuals associated with the homesharing activity data, for example, in a manner similar to that described at 104 of FIG. 1. The scores may indicate levels of performance of the one or more individuals with respect to homesharing activities. The method may include, at 508, identifying, based on the scores, a subset of the one or more individuals where the scores fail to satisfy one or more thresholds or where the scores satisfy the one or more thresholds, for example, in a manner similar to that at 106 of FIG. 1. The method may include, at 510, performing one or more actions based on the identification of the subset of the one or more individuals, for example, in a manner similar to that described at 108 or 110 of FIG. 1.

The method illustrated in FIG. 5 may include one or more additional aspects described below or elsewhere herein. In some embodiments, the scoring platform may include one or more of: one or more certificate managers, one or more security certificates, one or more load balancers, one or more availability zone, one or more virtual clouds, one or more cloud servers, one or more backup snapshots, one or more cloud storages, one or more security groups, one or more database instance managers, one or more database instance standbys, one or more cloud management services, and one or more alarm or notification services. In some embodiments, the method 500 may include validating that the homesharing activities occurred during a lease term. In some embodiments, the collecting at 502 may include collecting reservation-related data from the hosting platform, pricing information for homesharing activities provided by the one or more individuals, or rating information or review information for the homesharing activities provided by the one or more individuals.

In some embodiments, the method 500 may further include establishing a communications link to one or more accounts hosted on the homesharing platform for the one or more individuals, and the collecting at 502 may include collecting the homesharing activity data from the homesharing platform via the communications link. In some embodiments, the performing at 504 may include evaluating the levels of performance of the homesharing activities of the one or more individuals in relation to one or more other individuals or one or more thresholds. In some embodiments, the determining at 506 may include assigning point values to the homesharing activities of the one or more individuals using a machine learning model, multiplying the point values by a percentage associated with the homesharing activities, and summing resulting point values after the multiplying.

In some embodiments, the performing at 510 may include generating one or more recommendations for the homesharing activities provided by the one or more individuals, and outputting the one or more recommendations to one or more accounts hosted on one or more servers. The one or more accounts may be associated with the one or more individuals. In some embodiments, the performing at 510 may include applying one or more rewards or one or more penalties to one or more accounts associated with the one or more individuals. The one or more rewards or the one or more penalties may be based on the scores. In some embodiments, the performing at 510 may include generating recommendations related to the homesharing activities for the one or more individuals, and outputting the recommendations to user equipment associated with the one or more individuals. In some embodiments, the performing at 510 may include generating reports associated with the one or more individuals based on the scores, the analysis, or the homesharing activity data. In some embodiments, the collecting may include collecting reservation-related data from the hosting platform, pricing information from the pricing platform, and rating information or review information from the rating or review platform.

As described above, FIG. 5 is provided as an example. Other examples are possible according to some embodiments.

FIG. 6 illustrates an example of an apparatus 10 according to an embodiment. In an embodiment, apparatus 10 may be a node, host, or server in a communications network or serving such a network. For example, apparatus 10 may be a mobile client (e.g., a mobile client 404, such as a laptop computer, a mobile phone, a tablet, or a wearable device), a desktop computer, a computing device (e.g., of a scoring platform described herein), or the like. One or more apparatuses 10 may be connected via a wired network, a wireless network, or a combination of wired and wireless networks.

As illustrated in the example of FIG. 6, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 6, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device).

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry or control circuitry. In addition, in some embodiments, transceiver 18 may be included in or may form a part of transceiver circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be a mobile client or a computing device.

According to certain embodiments, apparatus 10 may be controlled by memory 14 and processor 12 to perform the functions associated with any of the embodiments described herein, such as some operations illustrated in, or described with respect to, FIGS. 1-5. For instance, apparatus 10 may be controlled by memory 14 and processor 12 to perform the method of FIG. 5.

In some embodiments, an apparatus (e.g., apparatus 10) may include means for performing a method or any of the variants discussed herein, e.g., a method described with reference to FIG. 5. Examples of the means may include one or more processors, memory, and/or computer program code for causing the performance of the operation.

Therefore, certain example embodiments provide several technological improvements, enhancements, and/or advantages over existing technological processes. For example, one benefit of some example embodiments is improved optimization of homesharing activity data. Accordingly, the use of some example embodiments results in an improvement at least to the technological field of homesharing data processing, among others. Additionally, or alternatively, another example benefit of some example embodiments is a fast, structured, and repeatable process for computer-based processing of homesharing activity data, and computer-based performance of actions based on the processing. This may improve an efficiency or speed of certain computer-based operations or conserve processing resources of a computer relative to other computer-based processing techniques. Accordingly, the use of some example embodiments results in an improvement at least to the technological field of computer-based operations.

In some example embodiments, the functionality of any of the methods, processes, signaling diagrams, algorithms or flow charts described herein may be implemented by software and/or computer program code or portions of code stored in memory or other computer readable or tangible media, and executed by a processor.

In some example embodiments, an apparatus may be included or be associated with at least one software application, module, unit or entity configured as arithmetic operation(s), or as a program or portions of it (including an added or updated software routine), executed by at least one operation processor. Programs, also called program products or computer programs, including software routines, applets and macros, may be stored in any apparatus-readable data storage medium and may include program instructions to perform particular tasks.

A computer program product may include one or more computer-executable components which, when the program is run, are configured to carry out some example embodiments. The one or more computer-executable components may be at least one software code or portions of code. Modifications and configurations used for implementing functionality of an example embodiment may be performed as routine(s), which may be implemented as added or updated software routine(s). In one example, software routine(s) may be downloaded into the apparatus.

As an example, software or a computer program code or portions of code may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10), for example through the use of an application specific integrated circuit (ASIC), a programmable gate array (PGA), a field programmable gate array (FPGA), or any other combination of hardware and software. In yet another example embodiment, the functionality may be implemented as a signal, such as a non-tangible means that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein apply equally to both singular and plural implementations, regardless of whether singular or plural language is used in connection with describing certain embodiments. For example, an embodiment that describes operations of a single computing device equally applies to embodiments that include multiple instances of the computing device, and vice versa. In addition, although certain embodiments have been described in the context of an individual, certain embodiments may also apply to non-human entities, such as a company, a governmental organization, and/or the like.

One having ordinary skill in the art will readily understand that the example embodiments as discussed above may be practiced with operations in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

We claim:

1. A method, comprising:
collecting, by a scoring platform, homesharing activity data, wherein the homesharing activity data is indicative of homesharing activities of one or more individuals and is collected from at least one of:
a homesharing platform,
a pricing platform, or
a rating or review platform;
performing an analysis of the homesharing activity data;
determining scores for the one or more individuals associated with the homesharing activity data, wherein the scores indicate levels of performance of the one or more individuals with respect to homesharing activities;
identifying, based on the scores, a subset of the one or more individuals where the scores fail to satisfy one or more thresholds or where the scores satisfy the one or more thresholds; and
performing one or more actions based on the identification of the subset of the one or more individuals.

2. The method according to claim 1, wherein the scoring platform comprises one or more of:
one or more certificate managers,
one or more security certificates,
one or more load balancers,
one or more availability zone,
one or more virtual clouds,
one or more cloud servers,
one or more backup snapshots,
one or more cloud storages,
one or more security groups,
one or more database instance managers,
one or more database instance standbys,
one or more cloud management services, and
one or more alarm or notification services.

3. The method according to claim 1, wherein the collecting of the homesharing activity data from the homesharing platform further comprises:
collecting reservation-related data from the hosting platform.

4. The method according to claim 1, wherein the collecting of the homesharing activity data from the pricing platform further comprises:
collecting pricing information for homesharing activities provided by the one or more individuals.

5. The method according to claim 1, wherein the collecting of the homesharing activity data from the rating or review platform further comprises:
collecting rating information or review information for the homesharing activities provided by the one or more individuals.

6. The method according to claim 1, wherein the performing of the one or more actions further comprises:
generating one or more recommendations for the homesharing activities provided by the one or more individuals; and
outputting the one or more recommendations to one or more accounts hosted on one or more servers, wherein the one or more accounts are associated with the one or more individuals.

7. The method according to claim 1, wherein the performing of the one or more actions further comprises:
applying one or more rewards or one or more penalties to one or more accounts associated with the one or more individuals, wherein the one or more rewards or the one or more penalties are based on the scores.

8. An apparatus, comprising:
at least one processor; and
at least one memory including computer program code,
wherein the at least one memory and the computer program code are configured to, with the at least one processor, cause the apparatus at least to:
collect homesharing activity data, wherein the homesharing activity data is indicative of homesharing activities of one or more individuals and is collected from at least one of:
a homesharing platform,
a pricing platform, or
a rating or review platform;
perform an analysis of the homesharing activity data;
determine scores for the one or more individuals associated with the homesharing activity data, wherein the scores indicate levels of performance of the one or more individuals with respect to homesharing activities;
identify, based on the scores, a subset of the one or more individuals, where the scores fail to satisfy one or more thresholds or wherein the scores satisfy the one or more thresholds; and
perform one or more actions based on the identification of the subset of the one or more individuals.

9. The apparatus according to claim 8, wherein the at least one memory and the computer program code are configured to, with the at least one processor, further cause the apparatus at least to:
establish a communications link to one or more accounts hosted on the homesharing platform for the one or more individuals; and
wherein the at least one memory and the computer program code are configured to, with the at least one processor, further cause the apparatus, when collecting the homesharing activity data, at least to:
collect the homesharing activity data from the homesharing platform via the communications link.

10. The apparatus according to claim 8, wherein the at least one memory and the computer program code are configured to, with the at least one processor, further cause the apparatus at least to:
validate that the homesharing activities occurred during a lease term.

11. The apparatus according to claim 8, wherein the at least one memory and the computer program code are configured to, with the at least one processor, further cause the apparatus, when determining the scores, at least to:
assign point values to the homesharing activities of the one or more individuals using a machine learning model;
multiply the point values by a percentage associated with the homesharing activities; and
sum resulting point values after the multiplying.

12. The apparatus according to claim 8, wherein the at least one memory and the computer program code are configured to, with the at least one processor, further cause the apparatus, when performing the one or more actions, at least to:
generate recommendations related to the homesharing activities for the one or more individuals; and
output the recommendations to user equipment associated with the one or more individuals.

13. The apparatus according to claim 8, wherein the at least one memory and the computer program code are configured to, with the at least one processor, further cause the apparatus, when collecting the homesharing activity data, at least to:
collect reservation-related data from the hosting platform, pricing information from the pricing platform, and rating information or review information from the rating or review platform.

14. The apparatus according to claim 8, wherein the apparatus further comprises one or more of:
one or more certificate managers,
one or more security certificates,
one or more load balancers,
one or more availability zones,
one or more virtual clouds,
one or more cloud servers,
one or more backup snapshots,
one or more cloud storages,
one or more security groups,
one or more database instance managers,
one or more database instance standbys,
one or more cloud management services, and
one or more alarm or notification services.

15. A non-transitory computer readable medium comprising program instructions for causing an apparatus to perform at least the following:
collect homesharing activity data, wherein the homesharing activity data is indicative of homesharing activities of one or more individuals and is collected from at least one of:
a homesharing platform,
a pricing platform, or
a rating or review platform;
perform an analysis of the homesharing activity data;
determine scores for the one or more individuals associated with the homesharing activity data, wherein the scores indicate levels of performance of the one or more individuals with respect to homesharing activities;
identify, based on the scores, a subset of the one or more individuals, where the scores fail to satisfy one or more thresholds or where the scores satisfy the one or more thresholds; and
perform one or more actions based on the identification of the subset of the one or more individuals.

16. The non-transitory computer readable medium according to claim 15, wherein the program instructions further comprise program instructions for causing the apparatus, when performing the analysis, to perform at least the following:
evaluate the levels of performance of the homesharing activities of the one or more individuals in relation to one or more other individuals or one or more thresholds.

17. The non-transitory computer readable medium according to claim 15, wherein the program instructions further comprise program instructions for causing the apparatus, when performing the one or more actions, to perform at least the following:
generate reports associated with the one or more individuals based on the scores, the analysis, or the homesharing activity data.

18. The non-transitory computer readable medium according to claim 15, wherein the program instructions further comprise program instructions for causing the apparatus, when performing the one or more actions, to perform at least the following:
generate recommendations related to the home sharing activities for the one or more individuals; and
output the recommendations to user equipment associated with the one or more individuals.

19. The non-transitory computer readable medium according to claim 15, wherein the program instructions further comprise program instructions for causing the apparatus, when collecting the homesharing activity data, to perform at least the following:
collect reservation-related data from the homesharing platform, pricing information from the pricing platform, and rating information or review information from the rating or review platform.

20. The non-transitory computer readable medium according to claim 15, wherein the program instructions further comprise program instructions for causing the apparatus, when performing the one or more actions, to perform at least the following:
generate recommendations for the homesharing activities provided by the one or more individuals; and
output the recommendations to accounts hosted on one or more servers, wherein the accounts are associated with the one or more individuals.
